(19) United States
(12) Patent Application Publication
(10) Pub. No.: US 2022/0116424 A1
(43) Pub. Date: Apr. 14, 2022

(54) MANAGEMENT SYSTEM, MANAGEMENT APPARATUS, AND COMPUTER-IMPLEMENTED METHOD

(71) Applicant: KONICA MINOLTA, INC., Tokyo (JP)

(72) Inventor: Kazuki HARADA, Kobe-shi (JP)

(73) Assignee: KONICA MINOLTA, INC., Tokyo (JP)

(21) Appl. No.: 17/488,841

(22) Filed: Sep. 29, 2021

(30) Foreign Application Priority Data
Oct. 12, 2020 (JP) 2020-171849

(51) Int. Cl. H04L 29/06

(52) U.S. Cl. CPC H04L 63/20; H04L 63/10

(57) ABSTRACT

A management system includes: a plurality of network devices that each control communication of a device; and a management apparatus. The management apparatus includes: a processor; and a memory that stores network device information including identification information and an installation area of each of the network devices, the identification information and the installation area being associated with each other. The processor performs receiving device information including identification information and an installation area of the device, and performing a process for changing whether or not to allow communication of the device. The performing a process for changing whether or not to allow communication of the device includes causing the network device corresponding to a same area as the installation area of the received device information to permit communication of the device corresponding to the identification information of the received device information.

The entire disclosure of Japanese Patent Application No. 2020-171849, filed on Oct. 12, 2020, is incorporated herein by reference in its entirety.

### BACKGROUND

### Technological Field

The present disclosure relates to a management system, a management apparatus, and a computer-implemented method.

### Description of the Related Art

In recent years, companies that manage resources such as their own devices using resource management software have been increasing. A management method using such resource management software requires a user to register information about a newly introduced device (e.g., identification information of the device, an installation area of the device, etc.) in the resource management software. Further, when the device information is changed, for example, when the installation area of the device is changed, the user needs to update the device information registered in the resource management software. However, when a device is newly introduced or the existing device is moved, the user may forget to update the device information on the resource management software. Thus, the installation area of the device registered in the resource management software may not coincide with the actual installation area of the device. In such a case, the user has to search for the device during inventory work.

Japanese Laid-Open Patent Publication No. 2006-332910 discloses a technique by which terminals whose communication is not permitted are not allocated with unnecessary IP addresses, and thus, terminals permitted to perform communication can start communication again without requiring permission for communication even after moving between network devices or between ports in a network device.

Japanese Laid-Open Patent Publication No. 2012-194846 discloses a technique by which, in response to an access request from a terminal device whose position information has been registered in advance, this registered position information is compared with the position information of the terminal device having issued the access request (the position information detected by detecting means), and when the former position information coincides with the latter position information, the access request is permitted.

### SUMMARY

According to the technique disclosed in Japanese Laid-Open Patent Publication No. 2006-332910, a device to which an IP address is allocated can access all networks under the Dynamic Host Configuration Protocol (DHCP) management. Accordingly, even when the device information on the resource management software is not updated, the device can perform communication. Thus, even if a user forgets to update the device information on the resource management software, the user cannot notice it. Further, according to the technique disclosed in Japanese Laid-Open Patent Publication No. 2012-194846, the position information of the terminal device is acquired utilizing the Global Positioning System (GPS) or base stations in a wireless network. Thus, it is possible to identify a building and a rough position where the terminal device is located, but it is difficult to identify a detailed position of the terminal device, such as the number of floor of the building where the terminal device is located and a specific position where the terminal device is located on the floor. Accordingly, when the installation area of the device registered in the resource management software does not coincide with the actual installation area of the device, the user has to search for the device, and thereby, inventory work takes longer time.

In view of the above-described circumstances, the efficiency of inventory work needs to be improved by providing a mechanism for grasping the latest installation area of a device.

To achieve at least one of the above-mentioned objects, according to an aspect of the present invention, a management system reflecting one aspect of the present invention comprises: a plurality of network devices that each control communication of a device used while being connected to a network and that each are provided on a communication path of the device; and a management apparatus that manages the device and each of the network devices. The management apparatus includes: a processor; and a memory that stores network device information including identification information and an installation area of each of the network devices, the identification information and the installation area being associated with each other. The processor performs receiving device information including identification information and an installation area of the device, and performing a process for changing whether or not to allow communication of the device. The performing a process for changing whether or not to allow communication of the device includes causing the network device corresponding to a same area as the installation area of the received device information to permit communication of the device corresponding to the identification information of the received device information.

A management apparatus according to an aspect is connected through a network to a plurality of network devices that each control communication of a device used while being connected to the network and that each are provided on a communication path of the device. The management apparatus includes: a processor; and a memory that stoles network device information including identification information and an installation area of each of the network devices, the identification information and the installation area being associated with each other. The processor performs receiving device information including identification information and an installation area of the device, and performing a process for changing whether or not to allow communication of the device. The performing a process for changing whether or not to allow communication of the device includes causing the network device corresponding to a same area as the installation area of the received device information to permit communication of the device corresponding to the identification information of the received device information.

A computer-implemented method according to an aspect includes: receiving device information including identification information and an installation area of a device; storing network device information including identification information and an installation area of a network device, the identification information and the installation area of the network device being associated with each other; and performing a process for changing whether or not to allow communication of the device. The performing a process for changing whether or not to allow communication of the device includes causing the network device corresponding to a same area as the installation area of the received device information to permit communication of the device corresponding to the identification information of the received device information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram for illustrating an overview of a management system.

FIG. 2 is a diagram showing a hardware configuration of a management apparatus.

FIG. 3 is a diagram showing a hardware configuration of a device.

FIG. 4 is a diagram showing a hardware configuration of a network device.

FIG. 5 is a diagram showing a functional configuration of the management system.

FIG. 6 is a diagram showing a network device information registration screen.

FIG. 7 is a diagram showing a network device information database.

FIG. 8 is a diagram showing a device information registration screen.

FIG. 9 is a diagram showing a device information database.

FIG. 10 is a flowchart illustrating a process of the management apparatus.

FIG. 11 is a flowchart illustrating a registration process.

FIG. 12 is a flowchart illustrating a series of processes for changing whether or not to allow communication of the device.

FIG. 13 is a flowchart illustrating a first setting changing process.

FIG. 14 is a flowchart illustrating a second setting changing process.

FIG. 15 is a flowchart illustrating a communication controlling process.

FIG. 16 is a flowchart illustrating a display process performed when a communication error occurs.

FIG. 17 is a diagram showing a screen that prompts inputting into the management apparatus.

FIG. 18 is a diagram showing a screen for instructing the network device to permit or prohibit communication of the device.

FIG. 19 is a diagram showing a device information registration screen according to a second embodiment.

FIG. 20 is a flowchart illustrating a series of processes for changing whether or not to allow communication of the device, according to the second embodiment.

FIG. 21 is a flowchart illustrating a first setting changing process according to the second embodiment.

FIG. 22 is a diagram showing a functional configuration of a management system according to a third embodiment.

FIG. 23 is a flowchart illustrating an activation process for a device according to the third embodiment.

FIG. 24 is a diagram showing a functional configuration of a management system according to a fourth embodiment.

FIG. 25 is a diagram showing a tag creation screen.

FIG. 26 is a diagram for illustrating a method of checking device information and correcting registered contents, using tags.

FIG. 27 is a diagram for illustrating a method of correcting registered contents using tags.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference characters, and names and functions thereof are also the same. Therefore, the detailed description thereof will not be repeated.

### First Embodiment

### <Overview of Management System>

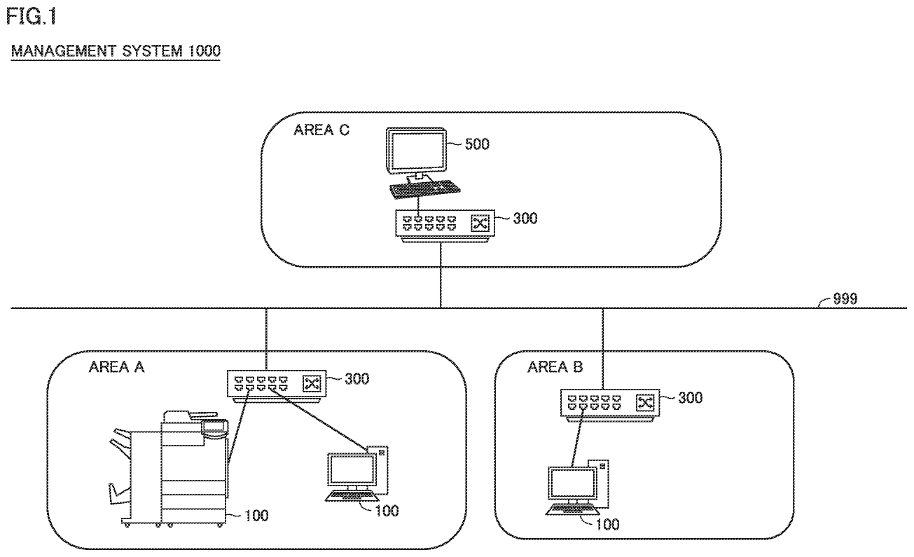

An overview of a management system will be hereinafter described with reference to FIG. 1. FIG. 1 is a diagram for illustrating an overview of a management system 1000. Management system 1000 includes one or more devices 100, a plurality of network devices 300, and one management apparatus 500.

Device 100 is, for example, an image forming apparatus, a printer, a personal computer (PC), or the like, and is used while being connected to a network 999. Device 100 cannot communicate with another device 100 or management apparatus 500 unless permitted by network device 300 provided in its installation area.

Network device 300 is provided on a communication path of device 100, and relays communication when device 100 communicates with another device 100 or management apparatus 500. Network device 300 is a router or a switching hub (an L2 switch or an L3 switch), for example. Network device 300 is provided in each installation area. In network device 300, the identification information (e.g., an Internet Protocol (IP) address, a Media Access Control (MAC) address, etc.) of device 100 whose communication is to be permitted is registered. Thus, only when the identification information included in the communication request is the identification information registered in network device 300, then, network device 300 permits the requested communication. In other words, network device 300 has an IP filtering function. Accordingly, when device 100 is newly introduced or when the installation area of device 100 is changed, device 100 cannot communicate with another device 100 or management apparatus 500 through network device 300 provided in its installation area unless the identification information of device 100 is registered in network device 300 provided in the installation area of device 100. In the present example, the identification information of management apparatus 500 is registered at least in network device 300 provided in an area C, and management apparatus 500 can communicate with device 100 through network device 300 provided in area C.

Management apparatus 500 manages device 100 and network device 300. In management system 1000, when management apparatus 500 receives an input of the device information (the identification information and the installation area of device 100) about a newly introduced device 100 or device 100 whose installation area has been changed, the input device information is stored in a hard disk drive (HDD) of management apparatus 500 and registered in network device 300 provided in the installation area of device 100. This allows device 100 to perform communication through network device 300 provided in its installation area.

Specifically, when the user installs device 100 in an area A and inputs the identification information of device 100 and the installation area (area A) of device 100 into management apparatus 500, the identification information of device 100 is registered in network device 300 provided in area A. This allows device 100 to perform communication through network device 300 provided in area A. Further, when the user moves device 100 from area A to an area B and inputs the identification information of device 100 and the installation area (area B) of device 100 into management apparatus 500, the identification information of device 100 is registered in network device 300 provided in area B and deleted from network device 300 provided in the past installation area (area A) of device 100. This allows device 100 to perform communication through network device 300 provided in area B but does not allow device 100 to perform communication through network device 300 provided in area A.

Thus, in management system 1000, in order for device 100 to perform communication through network device 300 provided in its installation area, the device information about device 100 needs to be input into management apparatus 500. Thereby, when device 100 is newly introduced or when the installation area of device 100 is changed, inputting of the device information about device 100 into management apparatus 500 is promoted, and thus, the latest installation area of device 100 is always stored in management apparatus 500. Consequently, the user can know the latest installation area of device 100 by checking the device information stored in management apparatus 500, and therefore, the user does not have to search for device 100 during inventory, thereby improving the efficiency of the inventory work.

In the present example, two areas (area A and area B) are provided as installation areas of device 100, but the number of installation areas of device 100 is not limited to two, and may be three or more.

In the present example, two devices 100 are provided in area A, and one device 100 is provided in area B, but the number of devices 100 installed in each installation area is not limited thereto. Further, device 100 may not be installed in some of the plurality of installation areas.

Further, in the present example, management apparatus 500 is provided in the area where device 100 is not provided, but may be provided in the area where device 100 is provided. When management apparatus 500 is provided in area A, however, the identification information of management apparatus 500 needs to be registered in network device 300 provided in area A, and the communication of management apparatus 500 needs to be permitted by network device 300 provided in area A. When management apparatus 500 is provided in area B, the identification information of management apparatus 500 needs to be registered in network device 300 provided in area B, and the communication of management apparatus 500 needs to be permitted by network device 300 provided in area B.

### <Hardware Configuration>

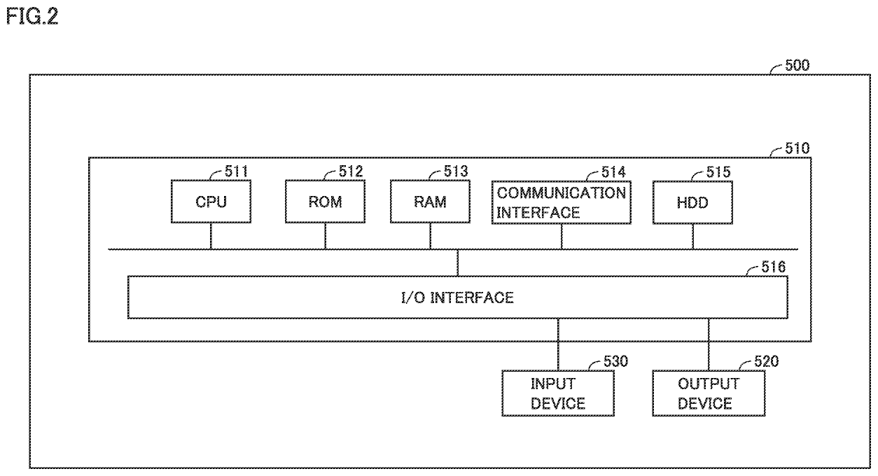

The following describes hardware configurations of the management apparatus, the device, and the network device with reference to FIGS. 2 to 4.

FIG. 2 is a diagram showing a hardware configuration of management apparatus 500. Management apparatus 500 includes a control device 510, an output device 520, and an input device 530. Control device 510 includes a central processing unit (CPU) 511, a read only memory (ROM) 512, a random access memory (RAM) 513, a communication interface 514, a hard disk drive (HDD) 515, and an input/output (I/O) interface 516.

CPU 511 comprehensively controls the entire management apparatus 500. CPU 511 deploys a program, which is stored in ROM 512, on RAM 513 for execution. ROM 512 stores a program describing a processing procedure of management apparatus 500. RAM 513 serves as a work area when CPU 511 executes a program, and temporarily stores the program, data used when executing the program, and the like. Communication interface 514 serves as an interface for communication with external devices (e.g., device 100, etc., shown in FIG. 1). HDD 515 is a nonvolatile storage device, and is an example of a “memory”. HDD 515 stores device information and network device information, which will be described later. I/O interface 516 is an interface for input into or output from control device 510. I/O interface 516 is connected to output device 520 and input device 530.

Output device 520 is a display, for example. Output device 520 displays a network device information registration screen and a device information registration screen, which will be described later. Input device 530 serves as a device through which an instruction from a user to management apparatus 500 is input. Input device 530 is a keyboard, a mouse, and/or a touch panel that is integrated with a display screen of output device 520. Input device 530 transmits the received input to control device 510.

Management apparatus 500 may not include output device 520 and input device 530. When management apparatus 500 does not include output device 520 and input device 530, the network device information registration screen and the device information registration screen are displayed on a mobile terminal connected to management apparatus 500 through network 999 (see FIG. 1), and the user uses this mobile terminal to input an instruction to management apparatus 500.

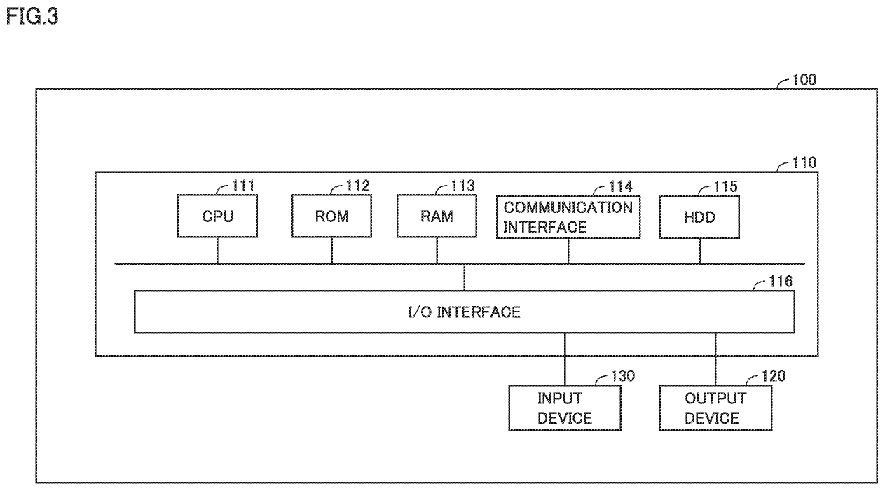

FIG. 3 is a diagram showing a hardware configuration of device 100. Device 100 includes a control device 110, an output device 120, and an input device 130. Control device 110 includes a CPU 111, a ROM 112, a RAM 113, a communication interface 114, an HDD 115, and an I/O interface 116.

CPU 111 comprehensively controls the entire device 100. CPU 111 deploys a program, which is stored in ROM 112, on RAM 113 for execution. ROM 112 stores a program describing a processing procedure of device 100. RAM 113 serves as a work area when CPU 111 executes a program, and temporarily stores the program, data used when executing the program, and the like. Communication interface 114 serves as an interface for communication with external devices (e.g., management apparatus 500, etc., shown in FIG. 1). HDD 115 is a nonvolatile storage device. I/O interface 116 is an interface for input into or output from control device 110. I/O interface 116 is connected to output device 120 and input device 130.

Output device 120 is a display, for example. Input device 130 serves as a device through which an instruction from a user to device 100 is input. Input device 130 is a keyboard, a mouse, and/or a touch panel that is integrated with a display screen of output device 120. Input device 130 transmits the received input to control device 110.

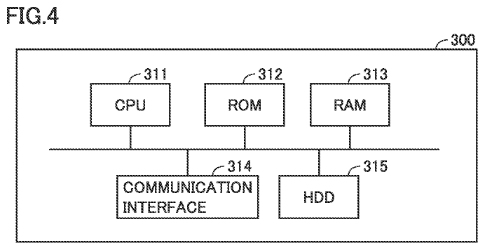

FIG. 4 is a diagram showing a hardware configuration of network device 300. Network device 300 includes a CPU 311, a ROM 312, a RAM 313, a communication interface 314, and an HDD 315.

CPU 311 comprehensively controls the entire network device 300. CPU 311 deploys a program, which is stored in ROM 312, on RAM 313 for execution. ROM 312 stores a program describing a processing procedure of network device 300. RAM 313 serves as a work area when CPU 311 executes a program, and temporarily stores the program, data used when executing the program, and the like. Communication interface 314 serves as an interface for communication with external devices (e.g., device 100, management apparatus 500, etc., shown in FIG. 1). HDD 315 is a nonvolatile storage device. HDD 315 stores a communication permission list, which will be described later.

### <Functions of Management System>

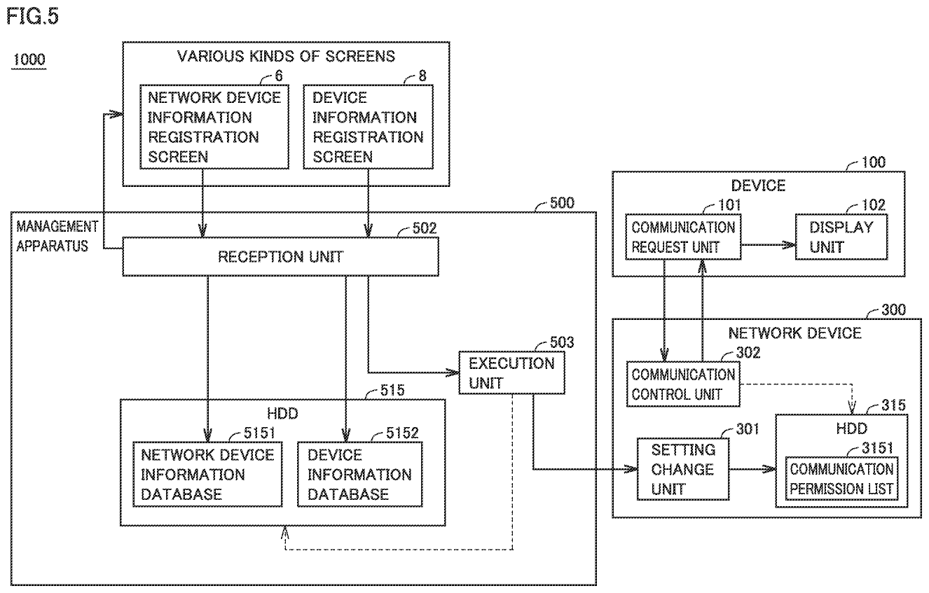

Each of functions of the management system will be hereinafter described with reference to FIGS. 5 to 9. FIG. 5 is a diagram showing a functional configuration of management system 1000. Management apparatus 500 includes a reception unit 502, an execution unit 503, and an HDD 515 as a memory. Reception unit 502 and execution unit 503 can be implemented by CPU 511 shown in FIG. 2 executing the program stored in ROM 512.

Upon receiving an instruction from the user to display network device information registration screen 6, reception unit 502 causes output device 520 (see FIG. 2) to display network device information registration screen 6. Upon receiving an instruction from the user to display device information registration screen 8, reception unit 502 causes output device 520 to display device information registration screen 8. Network device information registration screen 6 and device information registration screen 8 are screens displayed on a website on network 999 (see FIG. 1). Thus, network device information registration screen 6 and device information registration screen 8 may be displayed on a mobile terminal including a browser and connected to management apparatus 500 through network 999.

Reception unit 502 receives information input by the user through network device information registration screen 6, and stores the received information in a network device information database 5151 provided in HDD 515. Further, reception unit 502 receives information input by the user through device information registration screen 8, and stores the received information in a device information database 5152 provided in HDD 515.

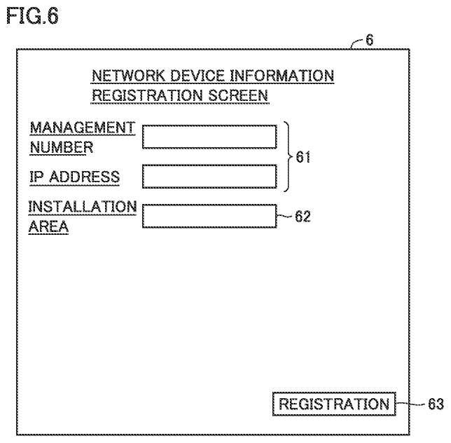

The following describes a registration screen and a database for the network device information or the device information with reference to FIGS. 6 to 9. FIG. 6 is a diagram showing network device information registration screen 6. Network device information registration screen 6 is a screen through which reception unit 502 (see FIG. 5) receives network device information, and is one example of a “first screen”. The network device information includes identification information and an installation area of network device 300. The identification information of network device 300 includes a management number of network device 300 and an IP address of network device 300. The installation area of network device 300 is an area in which network device 300 is installed. Network device information registration screen 6 includes: a field 61 in which the identification information of network device 300 is input; a field 62 in which an installation area of network device 300 is input; and a registration button 63 through which an instruction to register the information input into each field is given. When the user inputs information about network device 300 into each field and presses registration button 63, the input information is received by reception unit 502 and stored in network device information database 5151 (see FIG. 5).

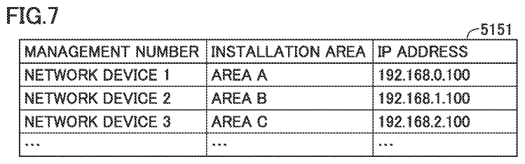

FIG. 7 is a diagram showing network device information database 5151. In network device information database 5151, the network device information received by reception unit 502 (see FIG. 5) is stored for each network device 300. Specifically, in network device information database 5151, the identification information of network device 300 received by reception unit 502 and the installation area of network device 300 received by reception unit 502 are stored in association with each other.

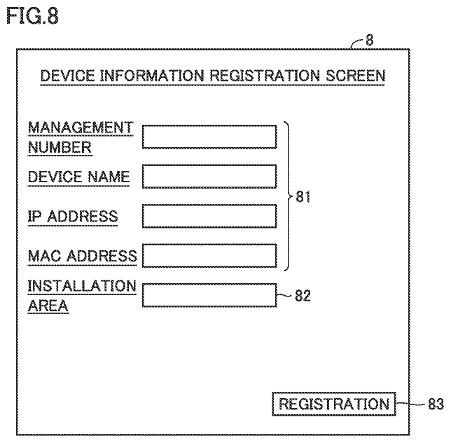

FIG. 8 is a diagram showing device information registration screen 8. Device information registration screen 8 is a screen through which reception unit 502 (see FIG. 5) receives the device information, and is one example of a “second screen”. The device information includes identification information and an installation area of device 100. The identification information of device 100 includes information (e.g., an IP address, a MAC address, etc.) that allows at least network device 300 to identify device 100. The installation area of device 100 is an area in which device 100 is installed. In management apparatus 500, only one installation area can be registered for one device 100.

Device information registration screen 8 includes: a field 81 in which the identification information of device 100 is input; a field 82 in which the installation area of device 100 is input; and a registration button 83 through which an instruction to register the information input into each field is given. In the present example, field 81 in which the identification information of device 100 is input is provided as a field in which the management number, the device name, the IP address, and the MAC address of device 100 are input, but may be provided at least as a field in which the information that allows network device 300 to identify device 100 is input. When the user inputs the information about device 100 into each field and presses registration button 83, the input information is received by reception unit 502 and stored in device information database 5152 (see FIG. 5).

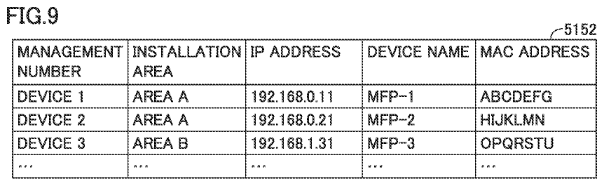

FIG. 9 is a diagram showing device information database 5152. Device information database 5152 stores the device information received by reception unit 502 (see FIG. 5) for each device 100. Specifically, in device information database 5152, the identification information of device 100 received by reception unit 502 and the installation area of device 100 received by reception unit 502 are stored in association with each other.

Again referring to FIG. 5, execution unit 503 executes a process for changing whether or not to allow communication of device 100. Specifically, execution unit 503 transmits a command to network device 300. The commands transmitted to network device 300 include two types of commands including a first command and a second command. The first command instructs network device 300 to permit communication of device 100. More specifically, the first command instructs network device 300 to register the identification information of device 100, which has been received by reception unit 502, in network device 300. The second command instructs network device 300 to prohibit communication of device 100. More specifically, the second command instructs network device 300 to delete the identification information of device 100, which has been received by reception unit 502, from network device 300.

Network device 300 includes a setting change unit 301, a communication control unit 302, and HDD 315. Setting change unit 301 and communication control unit 302 can be implemented by CPU 311 shown in FIG. 4 executing the program stored in ROM 312.

Setting change unit 301 performs the first setting change or the second setting change in accordance with the type of the command received from management apparatus 500. Specifically, when setting change unit 301 receives the first command from management apparatus 500, it adds the identification information of device 100, which has been received by reception unit 502, to communication permission list 3151 (the first setting change). On the other hand, when setting change unit 301 receives the second command from management apparatus 500, it deletes the identification information of device 100, which has been received by reception unit 502, from communication permission list 3151 (the second setting change). Communication permission list 3151 including identification information (an IP address or a MAC address) of device 100 whose communication is to be permitted is stored in HDD 315.

Communication control unit 302 permits or prohibits the requested communication based on the identification information of device 100 that is included in the requested communication. Specifically, when communication control unit 302 receives a communication request from device 100, it refers to communication permission list 3151 to determine whether or not the identification information of device 100 included in the requested communication is included in communication permission list 3151. When the result of the determination shows that the identification information of device 100 included in the requested communication is included in communication permission list 3151, communication control unit 302 permits the requested communication. When the result shows that the identification information of device 100 included in the requested communication is not included in communication permission list 3151, communication control unit 302 does not permit the requested communication.

Device 100 includes a communication request unit 101 and a display unit 102. Communication request unit 101 and display unit 102 can be implemented by CPU 111 shown in FIG. 3 executing the program stored in ROM 112.

When communication request unit 101 requests network device 300 to permit communication and then receives a communication error from network device 300, it notifies display unit 102 about reception of the communication error. Display unit 102 causes output device 120 (see FIG. 3) to show a notification to the user. For example, upon reception of a communication error from network device 300, display unit 102 causes output device 120 to show a screen that prompts inputting of the device information into management apparatus 500.

### <Process Performed by Management Apparatus>

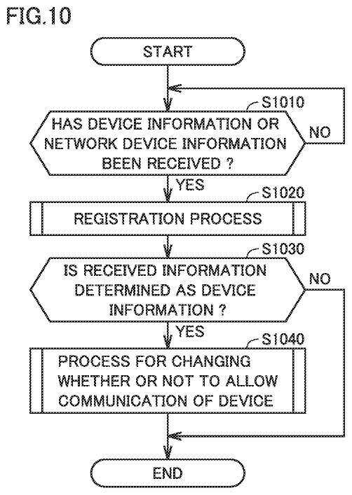

The process performed by the management apparatus will be hereinafter described with reference to FIGS. 5 and 10 to 12. FIG. 10 is a flowchart illustrating a process of management apparatus 500. The process shown in FIG. 10 can be implemented by CPU 511 shown in FIG. 2 executing the program stored in ROM 512.

Referring to FIGS. 5 and 10, in step S1010, management apparatus 500 determines whether or not it has received one of the device information and the network device information. When management apparatus 500 has received one of the device information and the network device information (YES in step S1010), it performs a registration process (step S1020).

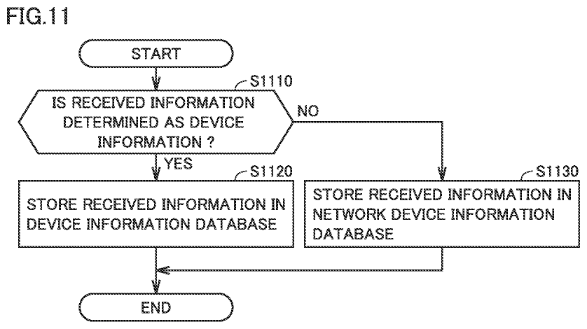

The registration process will be hereinafter described with reference to FIGS. 5 and 11. FIG. 11 is a flowchart illustrating the registration process. Management apparatus 500 causes CPU 511 to execute the program stored in ROM 512 (see FIG. 2), thereby implementing the registration process. In step S1110, management apparatus 500 determines whether the received information is the device information or not. When the received information is the device information (YES in step S1110), management apparatus 500 stores the received information in device information database 5152 (step S1120). On the other hand, when the received information is not the device information (NO in step S1110), management apparatus 500 stores the received information in network device information database 5151 (step S1130). After step S1120 or step S1130, management apparatus 500 ends the series of processes shown in FIG. 11. Through the series of processes shown in FIG. 11, the device information or the network device information is registered in management apparatus 500.

Again referring to FIGS. 5 and 10, in step S1030. management apparatus 500 determines whether the received information is the device information or not. When the received information is the device information (YES in step S1030), management apparatus 500 performs a process for changing whether or not to allow communication of device 100 (step S1040), and ends the series of processes shown in FIG. 10. On the other hand, when the received information is not the device information (NO in step S1030), management apparatus 500 ends the series of processes shown in FIG. 10.

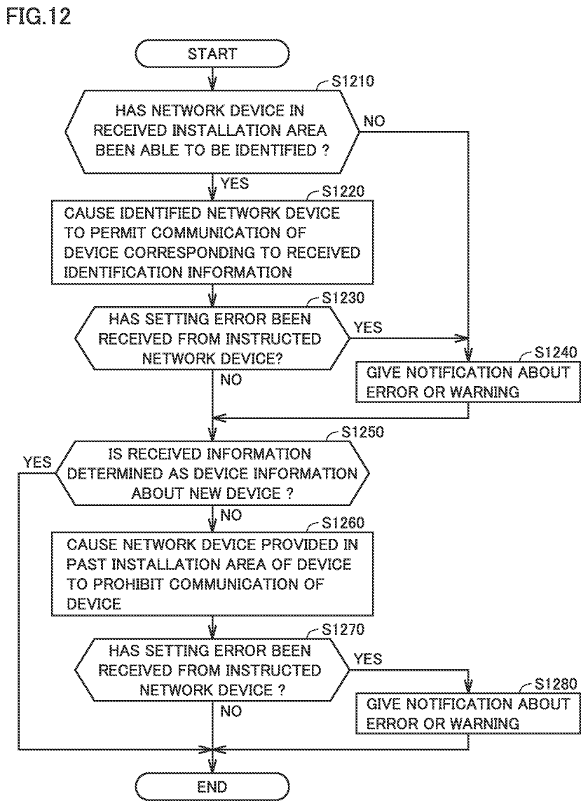

Referring to FIGS. 5 and 12, the process for changing whether or not to allow communication of the device will be hereinafter described. FIG. 12 is a flowchart illustrating a series of processes for changing whether or not to allow communication of device 100. Management apparatus 500 causes CPU 511 to execute the program stored in ROM 512 (see FIG. 2), thereby implementing the series of processes for changing whether or not to allow communication of device 100. The series of processes for changing whether or not to allow communication of device 100 includes: a process of causing network device 300 provided in the installation area of device 100 to permit communication of device 100 (the process in steps S1210 to S1240, which will be hereinafter referred to as a “first half process”); and a process of causing network device 300 provided in the past installation area of device 100 to prohibit communication of device 100 (the process in steps S1250 to S1280, which will be hereinafter referred to as a “latter half process”).

In step S1210, management apparatus 500 refers to network device information database 5151 to determine whether network device 300 corresponding to the same area as the received installation area (network device 300 in the received installation area) has been able to be identified or not. In step S1210, the received installation area means an installation area that has been input through device information registration screen 8.

When network device 300 corresponding to the same area as the received installation area has been able to be identified (YES in step S1210), management apparatus 500 shifts the process to step S1220. On the other hand, when network device 300 corresponding to the same area as the received installation area has not been able to be identified (NO in step S1210), management apparatus 500 shifts the process to step S1240.

In step S1220, management apparatus 500 causes the identified network device 300 to permit communication of device 100 corresponding to the received identification information. In step S1220, the received identification information means identification information that has been input through device information registration screen 8. Specifically, management apparatus 500 transmits a command (a first command), which gives an instruction to add the received identification information to communication permission list 3151, to network device 300 corresponding to the same area as the received installation area.

Then, management apparatus 500 determines whether or not it has been notified of a setting error from network device 300 that has been instructed to add the identification information (step S1230). When management apparatus 500 has been notified of a setting error from network device 300 that has been instructed to add the identification information (YES in step S1230), management apparatus 500 shifts the process to step S1240. On the other hand, when management apparatus 500 has not been notified of a setting error from network device 300 that has been instructed to add the identification information (NO in step S1230), management apparatus 500 shifts the process to step S1250.

In step S1240, management apparatus 500 gives a notification about an error or a warning. Specifically, management apparatus 500 causes output device 520 to display an error or a warning. After step S1240, management apparatus 500 shifts the process to step S1250.

In step S1250, management apparatus 500 determines whether or not the received information is the device information about a new device 100. In step S1250, new device 100 is a device whose device information is not registered in management apparatus 500, and means a newly introduced device. When the received information is the device information about new device 100 (YES in step S1250), management apparatus 500 ends the series of processes shown in FIG. 12. On the other hand, when the received information is not the device information about new device 100, i.e., when the received information is the device information about device 100 whose installation area has been changed (NO in step S1250), management apparatus 500 shifts the process to step S1260.

In step S1260, management apparatus 500 causes network device 300 provided in the past installation area of device 100 to prohibit communication of device 100. In step S1260, device 100 means device 100 corresponding to the received identification information, i.e., device 100 corresponding to the identification information that has been input through device information registration screen 8. Since device information database 5152 stores the device information received by reception unit 502, management apparatus 500 refers to device information database 5152 and thereby can identify the past installation area of device 100. After identifying the past installation area of device 100, management apparatus 500 refers to network device information database 5151 to identify network device 300 corresponding to the same area as the past installation area of device 100 as network device 300 provided in the past installation area of device 100. Then, to the identified network device 300, management apparatus 500 transmits a command (the second command) for giving an instruction to delete the received identification information from communication permission list 3151.

Then, management apparatus 500 determines whether or not it has been notified about a setting error from network device 300 that has been instructed to delete the identification information (step S1270). When management apparatus 500 has been notified about a setting error from network device 300 that has been instructed to delete the identification information (YES in step S1270), management apparatus 500 shifts the process to step S1280. On the other hand, when management apparatus 500 has not been notified about a setting error from network device 300 that has been instructed to delete the identification information (NO in step S1270), management apparatus 500 ends the series of processes shown in FIG. 12.

In step S1280, management apparatus 500 gives a notification about an error or a warning. Specifically, management apparatus 500 causes output device 520 to show an error or a warning. After step S1280, management apparatus 500 ends the series of processes shown in FIG. 12.

When the device information is input from a mobile terminal connected to management apparatus 500 through network 999 (see FIG. 1), an error or a warning may be displayed on the mobile terminal in steps S1240 and S1280. Further, when management apparatus 500 or the mobile terminal includes a speaker, a notification of an error or a warning may be given by sound in steps S1240 and S1280.

In the first half process, network device 300 provided in the installation area of device 100 is instructed to permit communication of device 100. In the latter half process, network device 300 provided in the past installation area of device 100 is instructed to prohibit communication of device 100.

### <Process Performed by Network Device>

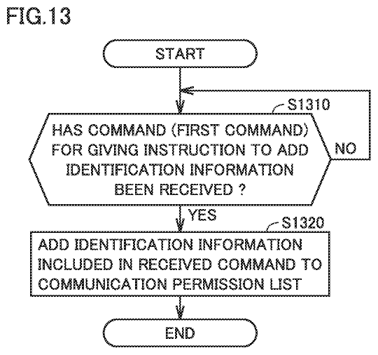

The process performed by the network device will be hereinafter described with reference to FIGS. 5 and 13 to 15. The processes shown in FIGS. 13 to 15 can be implemented by CPU 311 shown in FIG. 4 executing the program stored in ROM 312.

The setting changing process will be hereinafter described with reference to FIGS. 5, 13, and 14. Network device 300 causes CPU 311 to execute the program stored in ROM 312 (see FIG. 4), thereby implementing the setting changing process. The setting changing process includes two types of processes including a first setting changing process and a second setting changing process. The first setting changing process is performed when the first command is received, and performed to add the identification information included in the received command to communication permission list 3151. The second setting changing process is performed when the second command is received, and performed to delete the identification information included in the received command from communication permission list 3151.

The first setting changing process will be hereinafter described with reference to FIGS. 5 and 13. FIG. 13 is a flowchart illustrating the first setting changing process. In step S1310, network device 300 determines whether a command (the first command) for giving an instruction to add the identification information has been received or not. When the first command has been received (YES in step S1310), network device 300 adds the identification information included in the received command to communication permission list 3151 (step S1320).

After step S1320, network device 300 ends the series of processes shown in FIG. 13.

Through the series of processes shown in FIG. 13, the identification information of device 100 received by reception unit 502 is added to communication permission list 3151 in network device 300 provided in the installation area of device 100.

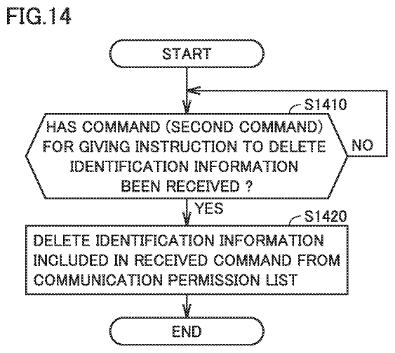

The second setting changing process will be hereinafter described with reference to FIGS. 5 and 14. FIG. 14 is a flowchart illustrating the second setting changing process. In step S1410, network device 300 determines whether or not it has received a command (the second command) for giving an instruction to delete the identification information. When network device 300 has received the second command (YES in step S1410), it deletes the identification information included in the received command from communication permission list 3151 (step S1420). After step S1420, network device 300 ends the series of processes shown in FIG. 14.

Through the series of processes shown in FIG. 14, the identification information of device 100 received by reception unit 502 is deleted from communication permission list 3151 in network device 300 provided in the past installation area of device 100.

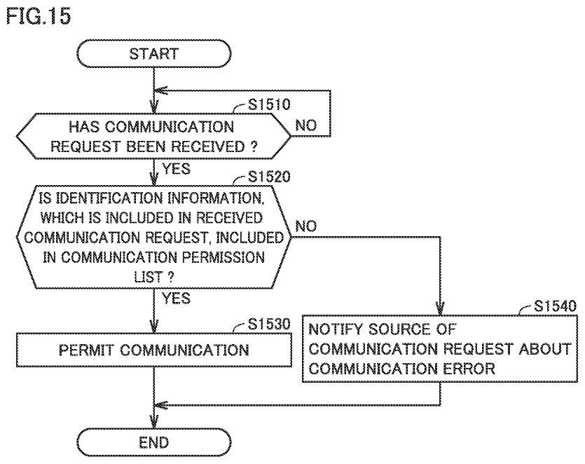

The communication controlling process will be hereinafter described with reference to FIGS. 5 and 15. FIG. 15 is a flowchart illustrating the communication controlling process. Network device 300 causes CPU 311 to execute the program stored in ROM 312 (see FIG. 4), thereby implementing the communication controlling process. In step S1510, network device 300 determines whether or not it has received a communication request. The communication request is transmitted from device 100 or management apparatus 500. When network device 300 has received the communication request (YES in step S1510), it shifts the process to step S1520.

In step S1520, network device 300 refers to communication permission list 3151, to determine whether or not communication permission list 3151 includes the identification information included in the received communication request. When communication permission list 3151 includes the identification information included in the received communication request (YES in step S1520), network device 300 permits communication (step S1530). When communication permission list 3151 does not include the identification information included in the received communication request (NO in step S1520), network device 300 notifies the source of the communication request about a communication error (step S1540).

After step S1530 or step S1540, network device 300 ends the series of processes shown in FIG. 15.

Through the series of processes shown in FIG. 15, communication is permitted only when communication permission list 3151 includes the identification information included in the communication request, and communication is prohibited when communication permission list 3151 does not include the identification information included in the communication request.

### <Process Performed by Device>

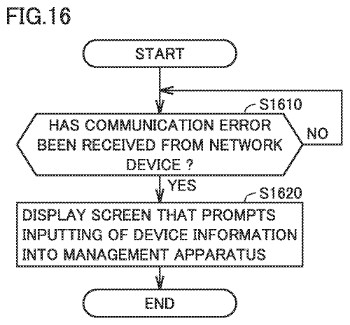

The display process performed by the device will be hereinafter described with reference to FIGS. 5 and 16. FIG. 16 is a flowchart illustrating the display process performed when a communication error occurs. Device 100 causes CPU 111 to execute the program stored in ROM 112 (see FIG. 3), thereby implementing the display process.

In step S1610, device 100 determines whether or not it has received a communication error from network device 300. When device 100 is notified about reception of the communication error from communication request unit 101, device 100 determines that it has received a communication error from network device 300. When device 100 has received a communication error from network device 300 (YES in step S1610), device 100 causes output device 120 (see FIG. 3) to display a screen that prompts inputting of the device information into management apparatus 500 (step S1620). After step S1620, device 100 ends the series of processes shown in FIG. 16.

Through the series of processes shown in FIG. 16, inputting of the device information into management apparatus 500 is prompted when a communication error occurs.

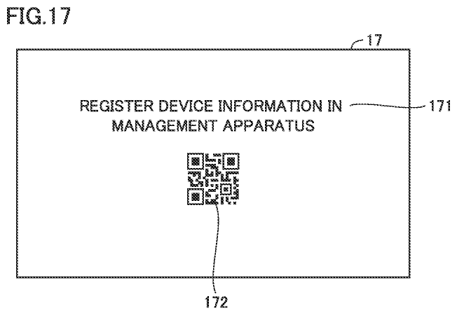

A screen displayed on device 100 will be hereinafter described with reference to FIGS. 5 and 17. FIG. 17 is a diagram showing a screen 17 that prompts inputting into management apparatus 500. Screen 17 is displayed on output device 120 (see FIG. 3) in step S1620 shown in FIG. 16. Screen 17 includes a message 171 that prompts inputting of the device information about device 100 into management apparatus 500, and a tag 172 that allows access to device information registration screen 8. Tag 172 is a QR code (registered trademark), DataMatrix (registered trademark), or the like, and can be read by a mobile terminal (an example of a “reading device”) connected to management apparatus 500 through network 999 (see FIG. 1). Tag 172 is assumed to be stored in HDD 115 (see FIG. 3) at the time of shipment of device 100 from a factory. Screen 17 may not include tag 172. Further, message 171 may include messages such as “Check device information registered in management apparatus. Correctly input device information into management apparatus”. Such messages displayed on screen 17 prompt inputting of the device information into reception unit 502.

As described above, in management system 1000 in the first embodiment, the device information about device 100 (the identification information and the installation area of device 100) needs to be input into management apparatus 500 in order for device 100 to perform communication through network device 300 provided in the installation area. Thereby, when device 100 is newly introduced or when the installation area of device 100 is changed, inputting of the device information about device 100 into management apparatus 500 is promoted, and the latest installation area of device 100 is always stored in management apparatus 500. Consequently, the user can know the latest installation area of device 100 by checking the device information stored in management apparatus 500, and therefore, the user does not have to search for device 100 during inventory, thereby improving the efficiency of the inventory work.

When the device information about device 100 is input into management apparatus 500, the identification information of device 100 is deleted from network device 300 provided in the past installation area of device 100. If the identification information of device 100 is not deleted from network device 300 provided in the past installation area of device 100, device 100 can undesirably perform communication through network device 300 provided in the past installation area, even though the device information about device 100 is not input into management apparatus 500 when device 100 is returned to the past installation area. This impairs the effect of promoting inputting of the device information about device 100 into management apparatus 500. However, in management system 1000, when the device information about device 100 is input into management apparatus 500, the identification information of device 100 is deleted from network device 300 provided in the past installation area of device 100. Thus, when device 100 is returned to the past installation area. device 100 cannot perform communication through network device 300 provided in this returned past installation area unless the device information about device 100 is input again into management apparatus 500. This prevents impairment of the effect of promoting inputting of the device information about device 100 into management apparatus 500.

In management system 1000, device 100 cannot perform communication through network device 300 provided in its installation area unless device information is input into management apparatus 500. In other words, in management system 1000, only device 100 whose device information is stored in management apparatus 500 can perform communication through network device 300 provided in its installation area. Thus, in the state where a device whose device information is not stored in management apparatus 500 is merely connected to network 999, such a device cannot perform communication through network device 300 provided in its installation area. Accordingly, management system 1000 can also be security countermeasures.

Further, in management system 1000, in the case where communication is not permitted when device 100 requests network device 300 provided in its installation area to permit communication, output device 120 of device 100 displays a screen that prompts inputting of the device information into management apparatus 500. This promotes inputting of the device information about device 100 into management apparatus 500.

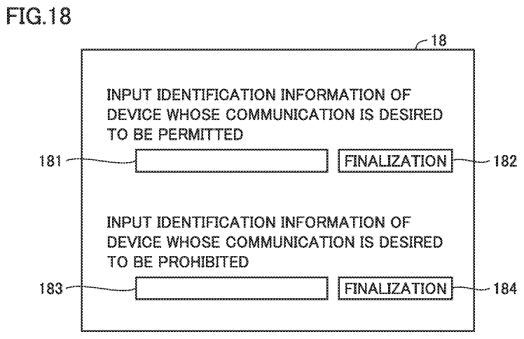

In the above description, execution unit 503 transmits to network device 300 a command for giving an instruction to permit or prohibit communication of device 100, but execution unit 503 may cause output device 520 to display a screen for instructing network device 300 to permit or prohibit communication of device 100, so as to cause the user to perform the operation on the screen. FIG. 18 is a diagram showing a screen 18 for instructing network device 300 to permit or prohibit communication of device 100. Referring to FIGS. 5 and 18, screen 18 is displayed on a website on network 999 (see FIG. 1). Screen 18 includes a field 181 and a finalization button 182. In field 181, the identification information of the device whose communication is desired to be permitted is input. Finalization button 182 serves to fix addition of the identification information, which has been input into field 181, to communication permission list 3151 in network device 300. Further, screen 18 includes a field 183 and a finalization button 184. In field 183, the identification information of the device whose communication is desired to be prohibited is input. Finalization button 184 serves to fix deletion of the identification information, which has been input into field 183, from communication permission list 3151 in network device 300. Execution unit 503 causes output device 520 to display screen 18 in steps S1220 and S1260. Specifically, in step S1220, execution unit 503 executes display of screen 18 of network device 300 corresponding to the same area as the installation area (network device 300 in the installation area) received by reception unit 502, thereby allowing the user to perform an operation for adding the identification information received by reception unit 502 to communication permission list 3151. In step S1260, execution unit 503 executes display of screen 18 of network device 300 corresponding to the same area as the past installation area of device 100 corresponding to the identification information received by reception unit 502, thereby allowing the user to perform an operation for deleting the identification information received by reception unit 502 from communication permission list 3151. Screen 18 may be displayed on a mobile terminal including a browser and connected to management apparatus 500 through network 999.

### Second Embodiment

The second embodiment will be hereinafter described. In the first embodiment, for one device 100, only one installation area of device 100 can be registered in management apparatus 500. In contrast, in the second embodiment, for one device, a plurality of installation areas can be registered in the management apparatus. When a plurality of installation areas are registered in the management apparatus for one device, however, a utilization time period needs to be set. Thereby, in the case of a device such as a mobile terminal whose utilization location frequently changes, the device information does not need to be registered each time the utilization location changes.

This prevents impairment of the user's convenience. Further, when a plurality of installation areas are registered in the management apparatus for one device, the utilization time period needs to be set. This prevents impairment of the effect of promoting inputting of the device information into the management apparatus. The following describes differences from management system 1000 in the first embodiment. The same configurations as those in the first embodiment are denoted by the same reference characters, and the description thereof will not be repeated.

The management system according to the second embodiment is different from management system 1000 according to the first embodiment in three points including: input items on the device information registration screen; a process for changing whether or not the management apparatus allows communication of a device; and the first setting changing process by the network device. Since other configurations and processes are the same as those in the first embodiment, the description thereof will not be repeated.

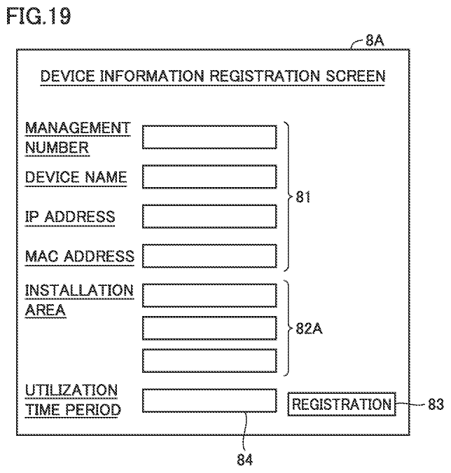

The following describes a device information registration screen according to the second embodiment with reference to FIGS. 5 and 19. FIG. 19 is a diagram showing a device information registration screen 8A according to the second embodiment. Device information registration screen 8A is different from device information registration screen 8 in the first embodiment in the following points. Specifically, device information registration screen 8A includes: a field 82A into which a plurality of installation areas of device 100 can be input; and a field 84 into which a utilization time period is input. Reception unit 502 controls the display on device information registration screen 8A such that, when a plurality of installation areas are input for device 100, registration button 83 cannot be selected unless a utilization time period is input. On the other hand, reception unit 502 controls the display on device information registration screen 8A such that, when only one installation area is input for device 100, registration button 83 can be selected even if no utilization time period is input. When the user inputs information about device 100 into each field and presses registration button 83, the input information is received by reception unit 502 and stored in device information database 5152.

Through device information registration screen 8A, the user can register a plurality of installation areas in management apparatus 500 for one device 100 on condition that a utilization time period is input. In FIG. 19, the number of fields in which an installation area is input for one device 100 is three, but is not limited to three as long as it is two or more.

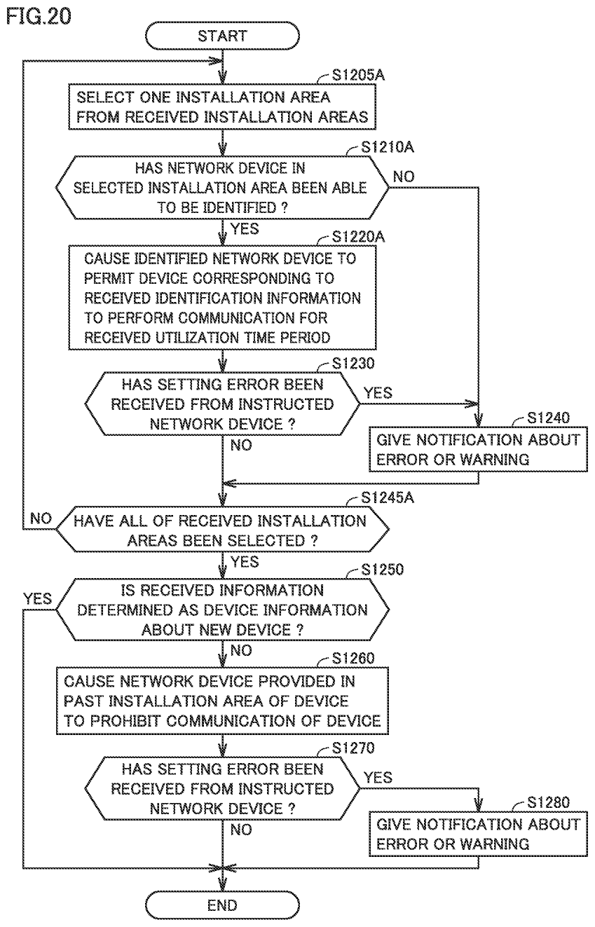

Referring to FIGS. 5, 19, and 20, the following describes a process for changing whether or not the management apparatus allows communication of the device, according to the second embodiment. FIG. 20 is a flowchart illustrating a series of processes for changing whether or not to allow communication of device 100, according to the second embodiment. Management apparatus 500 causes CPU 511 to execute the program stored in ROM 512 (see FIG. 2), thereby implementing a series of processes for changing whether or not to allow communication of device 100. In FIG. 20, the same steps as those shown in FIG. 12 are denoted by the same step numbers as those in FIG. 12. The process shown in FIG. 20 includes: a process of causing network device 300 provided in the installation area of device 100 to permit communication of device 100 (the process in steps S1205A to S1245A as a “first half process”); and a process of causing network device 300 provided in the past installation area of device 100 to prohibit communication of device 100 (the process in steps S1250 to S1280 as a “latter half process”). Also, a part of the first half process is different from the process shown in FIG. 12. Since the latter half process is the same as the process shown in FIG. 12, only the first half process will be described below.

In step S1205A, management apparatus 500 selects one installation area from the received installation areas. In step S1205A, the received installation areas each means an installation area that has been input on device information registration screen 8A.

Then, management apparatus 500 refers to network device information database 5151 to determine whether network device 300 corresponding to the same area as the selected installation area (network device 300 in the selected installation area) has been able to be identified or not (step S1210A). When network device 300 corresponding to the same area as the selected installation area has been able to be identified (YES in step S1210A), management apparatus 500 shifts the process to step S1220A. When network device 300 corresponding to the same area as the selected installation area has not been able to be identified (NO in step S1210A), management apparatus 500 shifts the process to step S1240.

In step S1220A, management apparatus 500 causes the identified network device 300 to permit device 100 corresponding to the received identification information to perform communication for the received utilization time period. In step S1220A, the received identification information means identification information that has been input on device information registration screen 8A. In step S1220A. the received utilization time period means a utilization time period that has been input on device information registration screen 8A. Specifically, management apparatus 500 transmits a command to network device 300, which corresponds to the same area as the selected installation area, for giving instructions to add the received identification information to communication permission list 3151 and to delete the identification information from communication permission list 3151 after the received utilization time period has elapsed.

Then, management apparatus 500 determines whether or not it has been notified about a setting error from network device 300 that has been instructed to add and delete the identification information (step S1230). When management apparatus 500 has been notified about a setting error from network device 300 that has been instructed to add and delete the identification information (YES in step S1230), management apparatus 500 shifts the process to step S1240. On the other hand, when management apparatus 500 has not been notified about a setting error from network device 300 that has been instructed to add and delete the identification information (NO in step S1230), management apparatus 500 shifts the process to step S1245A.

In step S1240, management apparatus 500 gives a notification about an error or a warning. Specifically, management apparatus 500 causes output device 520 to display an error or a warning. After step S1240, management apparatus 500 shifts the process to step S1245A.

In step S1245A, management apparatus 500 determines whether all of the received installation areas have been selected or not. When all of the received installation areas have been selected (YES in step S1245A), management apparatus 500 shifts the process to step S1250. On the other hand, when all of the received installation areas have not yet been selected (NO in step S1245A), management apparatus 500 returns the process to step S1205A.

Through the first half process, in each of all of the received installation areas, network device 300 is instructed to permit device 100 to perform communication for the received utilization time period. Further, through the latter half process, network device 300 provided in the past installation area of device 100 is instructed to prohibit communication of device 100.

In the following, the first setting changing process by the network device according to the second embodiment will be described with reference to FIGS. 5, 19, and 21. As described in the first embodiment, the first setting changing process is performed when the first command is received, and performed to add the identification information included in the received command to communication permission list 3151. Network device 300 causes CPU 311 to execute the program stored in ROM 312 (see FIG. 4), thereby implementing the first setting changing process. The first setting changing process in the second embodiment is different from the first setting changing process in the first embodiment in that the identification information added to communication permission list 3151 is deleted from communication permission list 3151 after the utilization time period has elapsed.

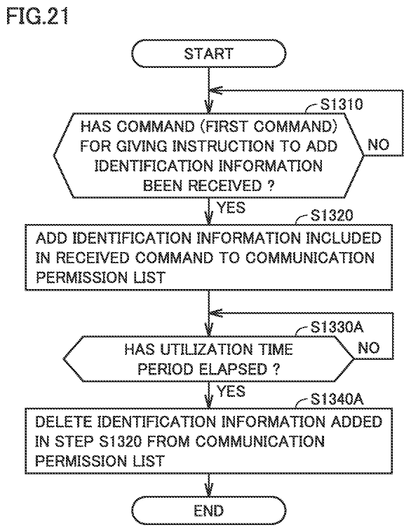

FIG. 21 is a flowchart illustrating the first setting changing process according to the second embodiment. The process shown in FIG. 21 can be implemented by CPU 311 shown in FIG. 4 executing the program stored in ROM 312. In FIG. 21, the same steps as those in FIG. 13 are denoted by the same step numbers as those in FIG. 13.

The process shown in FIG. 21 is different from the process shown in FIG. 13 in that steps S1330A and S1340A are performed after the process shown in FIG. 13. Thus, only steps S1330A and S1340A will be described below.

In step S1330A, network device 300 determines whether the utilization time period has elapsed or not. In step S1330A, the utilization time period means a utilization time period that has been input on device information registration screen 8A. When the utilization time period has elapsed (YES in step S1330A), network device 300 deletes the identification information added in step S1320 from communication permission list 3151 (step S1340A). After step S1340A, network device 300 ends the series of processes shown in FIG. 21.

Through a series of processes shown in FIG. 21, the identification information of device 100 is registered in network device 300 provided in each of the plurality of installation areas that have been input on device information registration screen 8A for the utilization time period that has been input on device information registration screen 8A. Accordingly, for this utilization time period, device 100 can perform communication through network device 300 provided in each of these input installation areas.

In this way, in the management system according to the second embodiment, the user can register a plurality of installation areas in management apparatus 500 for one device 100, and device 100 can perform communication through network device 300 provided in each of the plurality of installation areas. Thus, in the case of device 100 such as a mobile terminal whose utilization location frequently changes, the device information does not need to be registered again in management apparatus 500 each time the utilization location changes. This prevents impairment of the user's convenience.

On the other hand, if device 100 can permanently perform communication through network device 300 provided in each of the plurality of installation areas, the effect of promoting inputting of the device information about device 100 into management apparatus 500 is impaired. In the management system according to the second embodiment, however, a utilization time period needs to be input when a plurality of installation areas are registered in management apparatus 500 for one device 100. Also, only for the input utilization time period, device 100 can perform communication through network device 300 provided in each of the plurality of installation areas. This prevents impairment of the effect of promoting inputting of the device information about device 100 into management apparatus 500.

### Third Embodiment

Then, the third embodiment will be hereinafter described. In the first embodiment, the device information about device 100 needs to be registered in management apparatus 500 in order for network device 300 provided in installation area of this device 100 to permit communication of device 100, but the activation of device 100 is not limited. On the other hand, in the third embodiment, an activation lock is set active for a device at the time of factory shipment, and thus, the device cannot be activated unless it receives an activation key from the management apparatus. If the device cannot be activated, the device is not only unable to communicate with other devices through the network but also unable to execute applications mounted on the device and not using the network. The activation key is transmitted to the device at the time when the device information about the device is input into the management apparatus and received therein. Thus, inputting of the device information into the management apparatus is promoted when a device is newly introduced. The following describes differences from management system 1000 in the first embodiment. Also, the same configurations as those in the first embodiment are denoted by the same reference characters, and the description thereof will not be repeated.

The management system in the third embodiment is different from management system 1000 in the first embodiment in the following points. Specifically, in the management system in the third embodiment, an activation lock is set active for a device at the time of factory shipment, and the management apparatus transmits an activation key to the device. Since other configurations and processes are the same as those in the first embodiment, the description thereof will not be repeated.

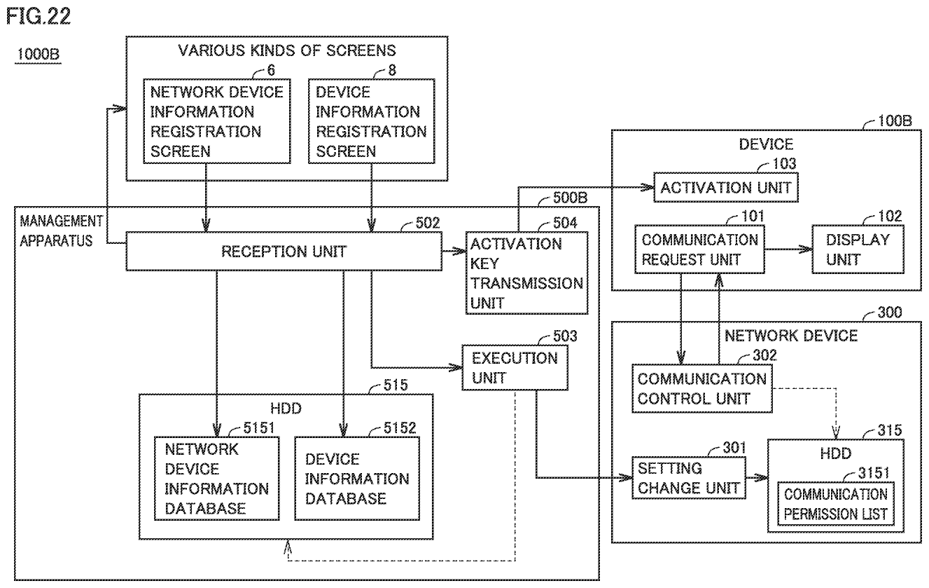

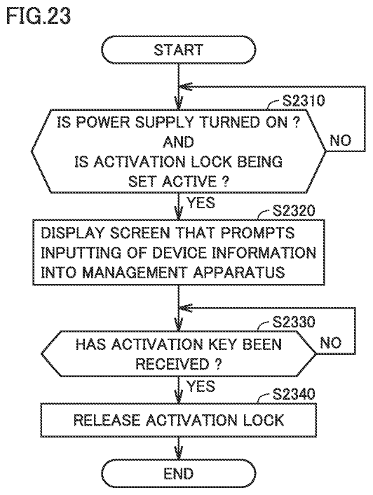

Referring to FIGS. 22 and 23, transmission of the activation key by the management apparatus and activation of the device will be hereinafter described. FIG. 22 is a diagram showing a functional configuration of a management system 1000B according to the third embodiment. Management system 1000B is different from management system 1000 shown in FIG. 5 in the following points. Specifically, in management system 1000B, management apparatus 500B includes an activation key transmission unit 504, and a device 100B includes an activation unit 103.

Activation key transmission unit 504 can be implemented by CPU 511 shown in FIG. 2 executing the program stored in ROM 512. When receiving from reception unit 502 a signal indicating that the device information about a new device 100B has been received, activation key transmission unit 504 transmits an activation key for permitting activation of device 100B to device 100B. New device 100B is a newly introduced device whose device information is not registered in management apparatus 500.

Activation unit 103 call be implemented by CPU 111 shown in FIG. 3 executing the program stored in ROM 112. When activation unit 103 receives the activation key from management apparatus 500, it releases the activation lock. This allows execution of various applications installed in device 100B.

FIG. 23 is a flowchart illustrating an activation process for device 100B according to the third embodiment. Device 100B causes CPU 111 shown in FIG. 3 to execute the program stored in ROM 112 (see FIG. 3), thereby implementing the activation process.

In step S2310, device 100B determines whether a power supply is turned on or not and the activation lock is being set active or not. When the power supply is turned on and the activation lock is being set active (YES in step S2310), device 100B causes output device 120 (see FIG. 3) to display a screen (e.g., screen 17 shown in FIG. 17) that prompts inputting of the device information about device 100B into management apparatus 500B as shown in FIG. 17 (step S2320).

In step S2330, device 100B determines whether the activation key has been received or not. When the activation key has been received (YES in step S2330), device 100B releases the activation lock (step S2340) and ends the series of processes shown in FIG. 23.

In this way, in management system 1000B in the third embodiment, the activation lock is set active for device 100B at the time of factory shipment. Accordingly, for releasing the activation lock, the device information about device 100B needs to be input into management apparatus 500B. Thereby, if the device information about device 100B is not input into management apparatus 500B when device 100B is newly introduced, device 100B is not only unable to communicate with other devices through the network but also unable to execute applications mounted on device 100B and not using the network. This promotes inputting of the device information about device 100B into management apparatus 500B.

### Fourth Embodiment

The fourth embodiment will be hereinafter described. A management system in the fourth embodiment provides a mechanism that saves time and effort required for a user to input device information into a management apparatus. This facilitates inputting of the device information about the device into the management apparatus. The following describes differences from management system 1000 in the first embodiment. The same configurations as those in the first embodiment are denoted by the same reference characters, and the description thereof will not be repeated.

The management system in the fourth embodiment is different from management system 1000 in the first embodiment in the following points. Specifically, in the management system in the fourth embodiment, the management apparatus has a function of creating a tag, and a mobile terminal for reading the tag created by the management apparatus is provided. Since other configurations and processes are the same as those in the first embodiment, the description thereof will not be repeated.

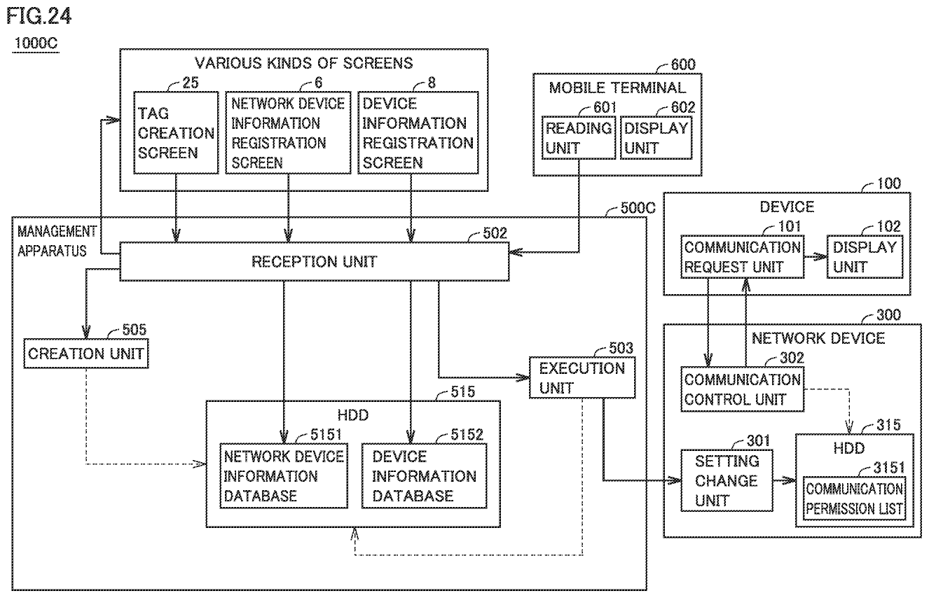

A functional configuration of a management system in the fourth embodiment will be hereinafter described with reference to FIG. 24. FIG. 24 is a diagram showing a functional configuration of a management system 1000C in the fourth embodiment. Management system 1000C is different from management system 1000 shown in FIG. 5 in that management system 1000C includes a mobile terminal 600 (an example of a “reading device”), and that management apparatus 500C includes a creation unit 505.

Creation unit 505 can be implemented by CPU 511 shown in FIG. 2 executing the program stored in ROM 512. Creation unit 505 creates a tag based on the information input through a tag creation screen 25. Tag creation screen 25 is displayed on output device 520 (see FIG. 2) by reception unit 502 that has received a display instruction from a user. Tag creation screen 25 is displayed on a website on network 999 (see FIG. 1) and therefore may be displayed on mobile terminal 600.

Mobile terminal 600 is connected to management apparatus 500C through network 999. Mobile terminal 600 includes a reading unit 601 that reads a tag created by creation unit 505, and a display unit 602 that shows a website on network 999 using a browser. Mobile terminal 600 includes a CPU, a ROM, a RAM, a communication interface, and an HDD. The CPU comprehensively controls the entire mobile terminal 600. The CPU deploys a program, which is stored in the ROM, on the RAM for execution. The ROM stores a program describing a processing procedure of mobile terminal 600. The RAM serves as a work area when the CPU executes a program, and temporarily stores the program, data used when executing the program, and the like. The communication interface serves as an interface for communication with external devices (e.g., management apparatus 500C, etc.). The HDD is a nonvolatile storage device.

The tags created by creation unit 505 include a first tag and a second tag. The first tag is accessible to the network device information stored in network device information database 5151, and is created for each network device. The second tag is accessible to the device information stored in device information database 5152, and is created for each device. The first tag and the second tag are readable by mobile terminal 600. The first tag and the second tag are, for example, QR codes, DataMatrix, or the like.

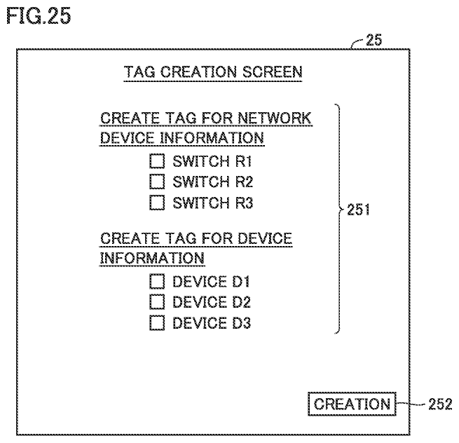

FIG. 25 is a diagram showing tag creation screen 25. Referring to FIGS. 24 and 25, tag creation screen 25 includes: a field 251 in which a tag desired to be created is designated; and a creation button 252 for instructing creation of the designated tag. For example, when creation button 252 is pressed in the state where “Switch R1” is selected, creation unit 505 creates the first tag that is accessible to the network device information of switch R1 stored in network device information database 5151. When creation button 252 is pressed in the state where “Device D1” is selected, creation unit 505 creates the second tag that is accessible to the device information of device D1 stored in device information database 5152. The created tag is output from a printer and attached onto network device 300 or device 100 by the user. For example, after registering the network device information in management apparatus 500C, the user causes management apparatus 500C to create the first tag, and attaches the created first tag onto corresponding network device 300. Further, after registering the device information in management apparatus 500C, the user causes management apparatus 500C to create the second tag, and attaches the created second tag onto corresponding device 100. The user uses mobile terminal 600 to read these tags, and thereby, can check the network device information or the device information or can correct the registered contents of the network device information or the device information.

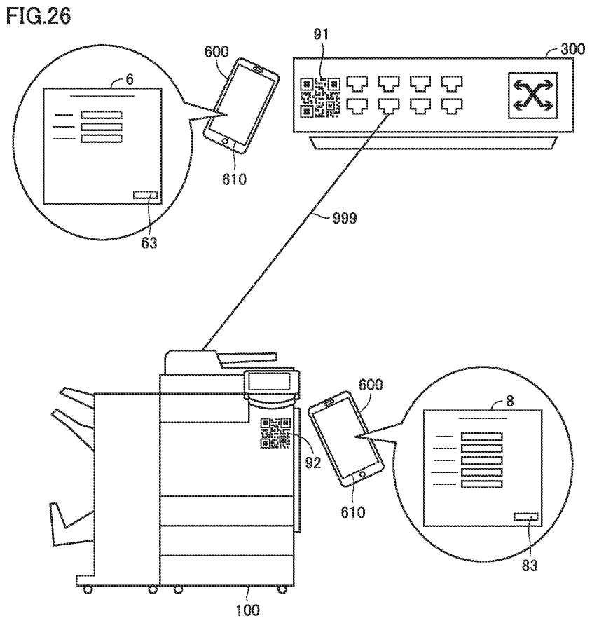

FIG. 26 is a diagram for illustrating a method of checking device information and correcting registered contents, using tags. Referring to FIGS. 24 and 26, a first tag 91 is attached onto network device 300, and a second tag 92 is attached onto device 100. Network device 300 and device 100 arc connected through network 999. When the user uses mobile terminal 600 to read first tag 91 alone, reception unit 502 creates network device information registration screen 6 in which the network device information accessed by first tag 91 is input into network device information registration screen 6 shown in FIG. 6. Using a browser, display unit 602 causes a display 610 to show network device information registration screen 6 created by reception unit 502. Thereby, the user can check the network device information, which is registered in management apparatus 500C, on mobile terminal 600.

Further, when the user corrects the information on network device information registration screen 6 displayed on mobile terminal 600 and then presses registration button 63, reception unit 502 receives the information input into network device information registration screen 6 as network device information. Thereby, the user can correct the information on network device information registration screen 6 displayed on mobile terminal 600 and press registration button 63 and thus can update the network device information.

When the user uses mobile terminal 600 to read second tag 92 alone, reception unit 502 creates device information registration screen 8 in which the device information accessed by second tag 92 is input into device information registration screen 8 shown in FIG. 8. Using a browser, display unit 602 causes display 610 to show device information registration screen 8 created by reception unit 502. Thereby, the user can check the device information, which is registered in management apparatus 500C, on mobile terminal 600.

When the user corrects the information on device information registration screen 8 displayed on mobile terminal 600 and then presses registration button 83, reception unit 502 receives the information input into device information registration screen 8 as device information. Thereby. the user can correct the information on device information registration screen 8 displayed on mobile terminal 600 and press registration button 83 and thus can update the device information.

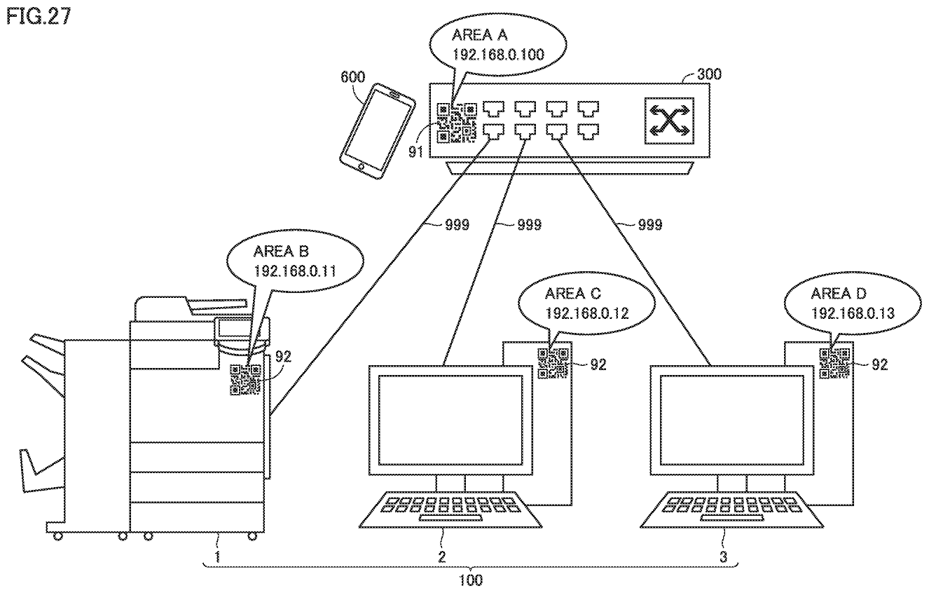

FIG. 27 is a diagram for illustrating a method of correcting registered contents using tags. Referring to FIGS. 24 and 27, devices 1, 2, and 3 each are an example of device 100 and assumed to be moved from another area to area A. It is assumed that devices 1, 2, and 3 have been previously installed in areas B, C, and D, respectively. The device information accessed by second tag 92 attached onto device 1 includes identification information of device 1 and information indicating the past installation area (area B) of device 1. The device information accessed by second tag 92 attached onto device 2 includes identification information of device 2 and information indicating the past installation area (area C) of device 2. The device information accessed by second tag 92 attached onto device 3 includes identification information of device 3 and information indicating the past installation area (area D) of device 3. The network device information accessed by first tag 91 attached onto network device 300 includes identification information of network device 300 and information indicating the installation area (area A) of network device 300. Network device 300 and device 100 are connected through network 999.

In order for devices 1, 2, and 3 to perform communication through network device 300 provided in area A, the user needs to again register the device information about each of devices 1, 2, and 3 in management apparatus 500C. In the present example, among the device information, the identification information is not changed, but only the information about the installation area is changed. As described in the first embodiment, the user may input the device information about devices one by one through device information registration screen 8, but may use mobile terminal 600 to sequentially read second tag 92 attached onto device 1, second tag 92 attached onto device 2, second tag 92 attached onto device 3, and first tag 91 attached onto network device 300, and thereby, can again register the device information about each of devices 1, 2, and 3 in management apparatus 500C.

Specifically, when the user uses mobile terminal 600 to sequentially read second tag 92 attached onto device 1, second tag 92 attached onto device 2, second tag 92 attached onto device 3, and first tag 91 attached onto network device 300, reception unit 502 receives the installation area accessed by first tag 91 as an installation area of device 100 corresponding to one or more pieces of identification information accessed by second tag 92.

In other words, reception unit 502 receives the identification information accessed by second tag 92 attached onto device 1 and the installation area accessed by first tag 91 as the device information about device 1. Further, reception unit 502 receives the identification information accessed by second tag 92 attached onto device 2 and the installation area accessed by first tag 91 as the device information about device 2. Further, reception unit 502 receives the identification information accessed by second tag 92 attached onto device 3 and the installation area accessed by first tag 91 as the device information about device 3.

FIG. 27 has been described regarding the method of correcting the registered contents using tags with reference to an example in which device information about each of three devices 100 whose installation areas have been changed is registered again in management apparatus 500C. However, the above-described method may be applicable to the case where the device information about each of one or more devices 100 whose installation areas have been changed is registered again in management apparatus 500C. Further, in the method described with reference to FIG. 27, first tag 91 and second tag 92 may be read in any order.

As described above, in management system 1000C according to the fourth embodiment, using tags saves the time and effort required for the user to input the device information into management apparatus 500C. This facilitates inputting of the device information about device 100 into management apparatus 500C.

Thus, each of the embodiments has been described as above. The embodiments can be combined arbitrarily.

Although embodiments of the present invention have been described and illustrated in detail, the disclosed embodiments are made for purposes of illustration and example only and not limitation. The scope of the present invention should be interpreted by terms of the appended claims.

What is claimed is:

1. A management system comprising:
a plurality of network devices that each control communication of a device used while being connected to a network and that each are provided on a communication path of the device; and
a management apparatus that manages the device and each of the network devices,
the management apparatus including
a processor, and
a memory that stores network device information including identification information and an installation area of each of the network devices, the identification information and the installation area being associated with each other,
the processor
receiving device information including identification information and an installation area of the device, and
performing a process for changing whether or not to allow communication of the device, wherein
the performing a process for changing whether or not to allow communication of the device includes causing the network device corresponding to a same area as the installation area of the received device information to permit communication of the device corresponding to the identification information of the received device information.

2. The management system according to claim 1, wherein the causing the network device to permit communication of the device includes transmitting a command to the network device for instructing the network device to permit communication of the device.

3. The management system according to claim 1, wherein the causing the network device to permit communication of the device includes providing a user with a screen for instructing the network device to permit communication of the device.

4. The management system according to claim 1, wherein the performing a process for changing whether or not to allow communication of the device includes causing the network device corresponding to a same area as a past installation area of the device corresponding to the identification information of the received device information to prohibit communication of the device corresponding to the identification information of the received device information.

5. The management system according to claim 4, wherein the causing the network device to prohibit communication of the device includes transmitting a command to the network device for giving an instruction to prohibit communication of the device.

6. The management system according to claim 4, wherein the causing the network device to prohibit communication of the device includes providing a user with a screen for instructing the network device to prohibit communication of the device.

7. The management system according to claim 1, wherein the network device is a router or a switching hub.

8. The management system according to claim 1, wherein
the receiving the device information includes receiving a plurality of installation areas for one device, and
the performing a process for changing whether or not to allow communication of the device includes, when the plurality of installation areas are received for the one device, causing the network devices corresponding to same areas as respective ones of the installation areas to
permit the device corresponding to the identification information of the received device information to perform communication for a prescribed time period, and
after the prescribed time period, prohibit communication of the device.

9. The management system according to claim 1, wherein
the memory stores the received device information,
the processor receives the network device information,
the processor
creates a first tag for each of the network devices, the first tag being accessible to the network device information stored in the memory, and
creates a second tag for each device, the second tag being accessible to the device information stored in the memory,
the first tag and the second tag each are information readable by a reading device,
when the first tag alone is read by the reading device, the processor creates a first screen in which the network device information accessed by the first tag is input, the first screen serving to receive the network device information, and
when the second tag alone is read by the reading device, the processor creates a second screen in which the device information accessed by the second tag is input, the second screen serving to receive the device information.

10. The management system according to claim 9, wherein the receiving the device information includes, when one first tag and one or more second tags are read by the reading device, receiving an installation area accessed by the one first tag as an installation area of each device that corresponds to a corresponding one of one or more pieces of identification information accessed by a corresponding one of the one or more second tags.

11. The management system according to claim 9, further comprising the device, wherein
the processor transmits an activation key that permits activation of the device to the device when the processor receives the device information, and
the device releases an activation lock of the device when the device receives the activation key.

12. The management system according to claim 11, wherein
the device displays a screen that prompts inputting of the device information when a power supply is turned on and the activation lock is set active,
the screen that prompts inputting of the device information includes a third tag that allows access to the second screen through which the device information is received, and
the third tag is information readable by the reading device.

13. The management system according to claim 12, wherein the device displays a screen that prompts inputting of the device information when the device is unable to perform communication through the network device.

14. A management apparatus connected through a network to a plurality of network devices that each control communication of a device used while being connected to the network and that each are provided on a communication path of the device, the management apparatus comprising:
a processor; and
a memory that stores network device information including identification information and an installation area of each of the network devices, the identification information and the installation area being associated with each other,
the processor
receiving device information including identification information and an installation area of the device, and
performing a process for changing whether or not to allow communication of the device, wherein
the performing a process for changing whether or not to allow communication of the device includes causing the network device corresponding to a same area as the installation area of the received device information to permit communication of the device corresponding to the identification information of the received device information.

15. The management apparatus according to claim 14, wherein the causing the network device to permit communication of the device includes transmitting a command to the network device for instructing the network device to permit communication of the device.

16. The management apparatus according to claim 14, wherein the causing the network device to permit communication of the device includes providing a user with a screen for instructing the network device to permit communication of the device.

17. The management apparatus according to claim 14, wherein the performing a process for changing whether or not to allow communication of the device includes causing the network device corresponding to a same area as a past installation area of the device corresponding to the identification information of the received device information to prohibit communication of the device corresponding to the identification information of the received device information.

18. A computer-implemented method comprising:
receiving device information including identification information and an installation area of a device;
storing network device information including identification information and an installation area of a network device, the identification information and the installation area of the network device being associated with each other; and
performing a process for changing whether or not to allow communication of the device, wherein
the performing a process for changing whether or not to allow communication of the device includes causing the network device corresponding to a same area as the installation area of the received device information to permit communication of the device corresponding to the identification information of the received device information.

19. The computer-implemented method according to claim 18, wherein the causing the network device to permit communication of the device includes transmitting a command to the network device for instructing the network device to permit communication of the device.

20. The computer-implemented method according to claim 18, wherein the causing the network device to permit communication of the device includes providing a user with a screen for instructing the network device to permit communication of the device.
